(19) United States
(12) Patent Application Publication
(10) Pub. No.: US 2025/0172016 A1
(43) Pub. Date: May 29, 2025

(54) LOCK APPARATUS WITH SLIDE BAR MOUNTED TO PIVOTING HOUSING

(71) Applicant: YARDLOCK CORPORATION, Mississauga (CA)

(72) Inventor: Donald William WEPF, Grimsby (CA)

(21) Appl. No.: 18/841,092

(22) PCT Filed: Mar. 10, 2023
(86) PCT No.: PCT/CA2023/050320

§ 371 Date: Aug. 23, 2024

Related U.S. Application Data
(60) Provisional application No. 63/319,100, filed on Mar. 11, 2022.

(51) Int. Cl. E05B 65/00; E05B 9/02; E05B 37/02; E05B 55/00

(52) U.S. Cl. CPC E05B 65/0021; E05B 9/02; E05B 37/02; E05B 55/00

(57) ABSTRACT

A lock apparatus for securing a door in a closed position is disclosed. The lock apparatus includes a housing and a slide bar that extends through the housing and is disposed for displacement relative to the housing between a first, retracted position and a second, extended position, while the housing is disposed in an open position. While the housing is disposed in a closed position, sliding displacement of the slide bar between the first and second positions is prevented due to interference between the slide bar and an interfering member disposed on a cover portion of the housing. The housing further comprises a housing lock that is operable between a locked condition and an unlocked condition, the housing lock configured for securing the housing in the closed position, while in the locked condition, to prevent unauthorized access to the sliding mechanism of the slide bar.

### CROSS-REFERENCE TO RELATED APPLICATION(S)

This application claims the benefit of priority to U.S. Provisional Application No. 63/319,100 filed Mar. 11, 2022, titled “LOCK APPARATUS”, the contents of which are hereby expressly incorporated into the present application by reference in their entirety.

### FIELD

The present disclosure relates to a lock apparatus for securing doors or gates in a closed, locked position.

### BACKGROUND

Various types of locks exist for securing doors and/or other barriers in a closed position to prevent unwanted entry or unwanted access to a particular space or area. Hinged doors or gates, sliding doors, and roll-up doors are some examples of doors that require robust lock systems to prevent unauthorized access to a particular area or space.

Roll-up doors, often used as garage doors, store-front security doors, and cargo hold doors on cargo trucks, typically use a latch handle or latch handle assembly for securing the door in a closed position. The latch handle is configured to cooperate with a corresponding portion of the frame that defines the door opening (or cargo hold) to secure the door in the closed position. A secondary lock, such as a conventional padlock, is often used to secure the latch handle in the closed position to prevent unwanted opening of the door, thereby locking the rolling door in the closed position.

The use of a secondary padlock is not always convenient as it can be vulnerable to tampering and is also at risk of being lost and/or misplaced when the padlock is removed in order to open the door. As well, conventional latch handle assemblies are often suitable for use in a particular orientation and/or location on a roll-up door in order to provide a secure lock and therefore are not as adaptable to various structures and/or door set-ups. For example, roll-up cargo doors as used in cargo trucks often require that the latch handle be positioned at the central bottom portion of the door for cooperating with a corresponding latch or bolt fitted to the base of the cargo hold. Other latch handle assemblies are only suitable for a right-handed orientation or right-handed use.

Residential garage doors often work on a remote control system allowing users to open and close the garage door easily and without difficulty from the inside and the outside. In some instances, it is desirable to secure these doors in the closed position by providing an additional lock installed on either the inside or the outside of the door to prevent un-wanted opening of the door, even via remote control. In some instances, positioning the additional lock on the inside of the door helps to reduce the likelihood of tampering with the lock or lock system. However, positioning the additional lock in the inside of the door is not suitable in instances where the space does not provide for a secondary access into the locked space. Accordingly, locks and/or lock systems that can be installed on the exterior and/or interior of the door and that can be easily adapted for either right hand or left hand use for cooperating with the for locking a door in a closed position are desirable.

Hinged doors and/or gates also require robust locks and/or lock systems for securing the door and/or gate in a closed position. In some instances it is desirable to provide a lock on the outside of the door to allow authorized access to an area or space from the outside. In other instances, it is desirable to provide locks on the inside of a hinged door or gate to only allow the door or gate to open from the outside once the interior lock has been opened.

Accordingly, locks and/or lock systems that are convenient and adaptable to various structures while providing a secure and robust lock for doors are desirable.

### SUMMARY

According to an aspect of the present disclosure there is provided a lock apparatus, comprising a housing, the housing including a base and a cover portion pivotally connected to the base such that the cover portion is pivotable, relative to the base, between a closed position and an open position. A slide bar is mounted to the base, wherein the slide bar is disposed for sliding movement relative to the base between a first position, wherein the slide bar is disposed in a retracted position, and a second position, wherein the slide bar is disposed in an extended position. A slide bar-interfering member is mounted to the cover portion and configured for preventing sliding movement of the slide bar between the first position and the second position while the cover portion is disposed in the closed position; and a housing lock is coupled to the housing and operable between a locked condition and an unlocked condition for securing the cover portion in the closed position. The base, the cover portion, the slide bar, the slide bar interfering member are cooperatively configured such that while the cover portion is disposed in the open position, the slide bar is displaceable between the between the first position and the second position, or vice versa; and while the slide bar is disposed in either one of the first position and the second position, and while the cover portion is disposed in the closed position, displacement of the slide bar slide bar from either the first position to the second position, or from the second position to the first position, is prevented via interference between the slide bar and the slide bar-interfering member.

A lock assembly for securing a door in a closed position, wherein the door is mounted relative to a frame member and is disposed for displacement relative to the frame member between a closed position wherein the door and the frame member share an interface, and an open position wherein the door is disposed relative to the frame member such that at least a portion of the shared interface is defeated, the lock assembly comprising: a lock apparatus mounted on one of the door or a corresponding portion of the door frame and a receiver mounted on the other one of the one of the door or a corresponding portion of the door frame; the lock apparatus comprising: a housing, the housing including a base; and a cover portion pivotally connected to the base such that the cover portion is pivotable, relative to the base, between a closed position and an open position; a slide bar mounted to the base, wherein the slide bar is disposed for sliding movement relative to the base between a first position, wherein the slide bar is disposed in a retracted position; and a second position, wherein the slide bar is disposed in an extended position such that an end portion of the side bar is disposed within the receiver. A slide bar-interfering member mounted to the cover portion and configured for preventing sliding movement of the slide bar between the first position and the second position while the cover portion is disposed in the closed position; and a housing lock coupled to the housing and operable between a locked condition and an unlocked condition for securing the cover portion in the closed position; wherein the base, the cover portion, the slide bar, the slide bar interfering member are cooperatively configured such that while the cover portion is disposed in the open position, the slide bar is displaceable between the between the first position and the second position, or vice versa; and while the slide bar is disposed in either one of the first position and the second position, and while the cover portion is disposed in the closed position displacement of the slide bar slide bar from either the first position to the second position, or from the second position to the first position, is prevented via interference between the slide bar and the slide bar-interfering member.

### BRIEF DESCRIPTION OF THE DRAWINGS

Reference will now be made, by way of example, to the accompanying drawings which show example embodiments of the present application, and in which:

FIG. 1 is a perspective view of an example embodiment of a lock apparatus according to the present disclosure while in a closed, un-latched condition;

FIG. 2 is a perspective view of the lock apparatus of FIG. 1 in an open, unlatched condition;

FIG. 3 is a perspective view of the lock of FIG. 1 in an open, latched condition;

FIG. 4 is a perspective view of the lock of FIG. 1 in a closed and locked condition;

FIG. 5 is a schematic view of the lock apparatus mounted for use with a rolling or roll-up door;

FIG. 6 is a schematic view of the lock apparatus of FIG. 5 in an un-locked or un-latched condition for allowing opening of the rolling or roll-up door;

FIG. 7 is a front view of the lock apparatus with a corresponding strike plate;

FIG. 8 is a perspective view of the lock apparatus and strike plate of FIG. 7;

FIG. 9 is a side view of the lock apparatus with corresponding strike plate of FIG. 8;

FIG. 10 is a rear view of the lock apparatus of FIG. 8;

FIG. 11 is a top end view of the lock apparatus with corresponding strike plate while the lock apparatus is in the unlatched condition;

FIG. 12 is a top end view of the lock apparatus with the corresponding strike plate while the lock apparatus is in the latched condition;

FIG. 13 is a detail perspective view of the lock apparatus mounted to a door for left-hand operation with the housing in the open condition and the slide bar in the latched condition; and

FIG. 14 is a front perspective view of the lock apparatus mounted to a door for right-hand operation of the apparatus and disposed in the locked condition with the housing in the closed position.

Similar reference numerals may have been used in different figures to denote similar components.

### DESCRIPTION OF EXAMPLE EMBODIMENTS

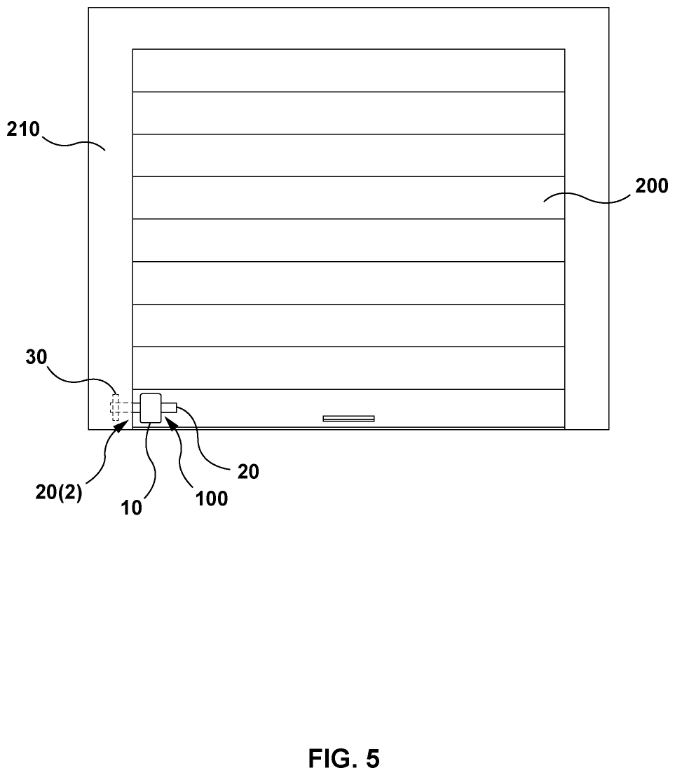

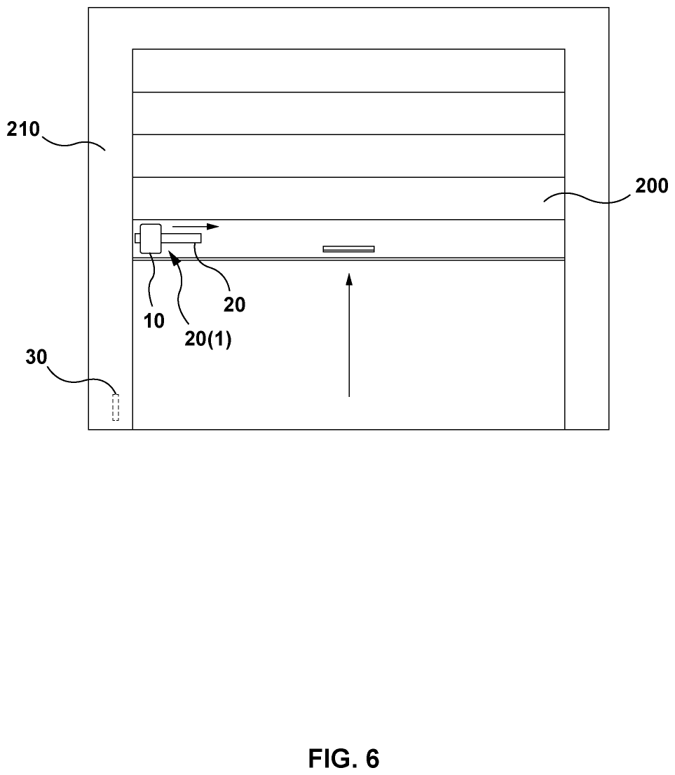

The present disclosure relates to a lock apparatus 100 configured for locking a door 200 in a closed position such that unauthorized access or entry to an area is prevented. With reference, in particular to FIGS. 5 and 6, the door 200 is mounted within a door frame 210 and is disposed for displacement between an open position and closed position. In some embodiments, for example, the lock apparatus 100 is configured for connection to an exterior surface of the door 200 and is configured for cooperating with a corresponding receiver 30 that is secured to or recessed within the door frame 210 such that the receiver 30 forms part of the door frame 210. When the lock apparatus 100 is disposed in a latched and locked condition, as shown for example in FIG. 5, the latch or slide bar 20 of the lock apparatus 100 is disposed within the receiver 30 such that the door 200 is prevented from opening due to the interference between the latch or slide bar 20 of the lock apparatus 100 and the receiver 30 that forms part of the door frame 210. When the lock apparatus 100 is disposed in an un-latched condition, as shown for example, in FIG. 6, there is an absence of interference between the latch or slide bar 20 of the lock apparatus 100 and the receiver 30 within the door frame 210 such that opening of the door 200 is permitted. In some embodiments, for example, the receiver 30 may be a slot or groove or recess formed within a cooperating surface of the door frame 210. In some embodiment, for example, the receiver 30 may be a bracket that is configured for receiving an end of the slide bar 20 or latch. In other embodiments, for example, the lock apparatus 100 may be mounted on the inside of the door 200 or door frame 210, or on the inside of a fence with a gate opening, to secure the door and/or gate in a closed position from the inside. In such instances, access to an area or space through the door or gate, for the outside, is only permissible when the lock apparatus 100 is disposed in the open or unlocked condition. In some instances it is desirable to locate the lock apparatus 100 on the inside of a door and/or gate to prevent tampering with the lock apparatus 100.

In some embodiments, for example, the lock apparatus 100 is configured for use with a rolling or roll-up door, as illustrated for example in FIGS. 5 and 6. However, it will be understood that the lock apparatus 100 is not limited to use with a roll-up door and that the lock apparatus 100 can be used for securing other styles of doors and/or gates in a closed position. As well, while the lock apparatus 100 illustrated in FIGS. 5 and 6 is shown connected to a left hand side of the rolling door 200 wherein sliding displacement of the latch or slide bar 20 to the left is effective for disposing the lock apparatus 100 in the latched condition, it will be understood that the lock apparatus 100 can also be adapted for use on the right hand side of a door 200 where sliding displacement of the latch or slide bar 20 to the right is effective for disposing the lock apparatus 100 in the latched condition. Accordingly, it will be understood that the lock apparatus 100 can be adapted to best suit a particular application and/or door and door frame configuration. As set out above, while the lock apparatus 100 is particularly suited for use with rolling or roll-up doors, as typically found in loading docks of large retail stores, factories and/or office buildings, or used as garage doors or security doors over storefronts, it will be understood that the lock apparatus 100 can be adapted for use with other types of doors and is not necessarily limited for use with rolling or roll-up doors.

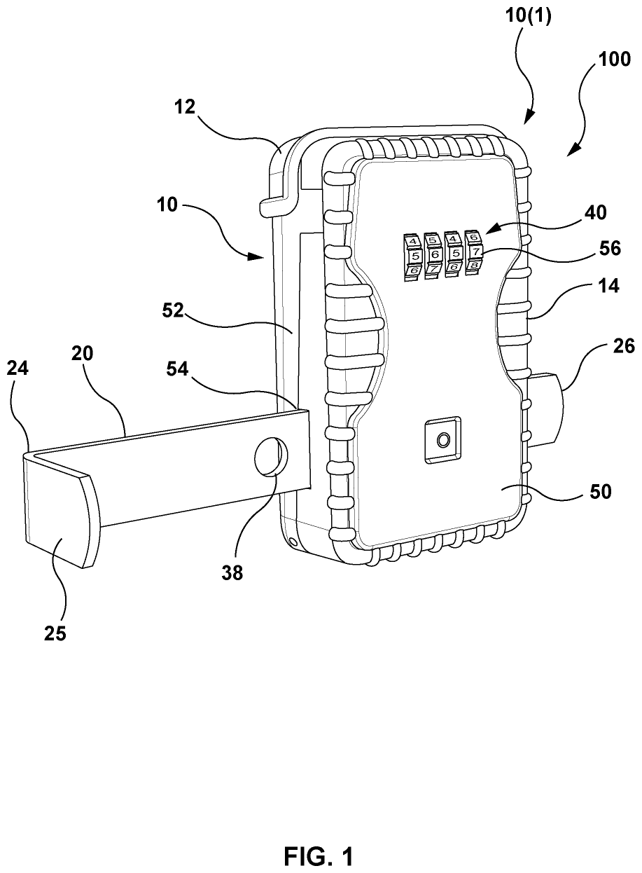

With reference now to FIGS. 1-4 there is shown an example embodiment of a lock apparatus 100 according to the present disclosure. The lock apparatus 100 includes a housing 10 and a latch or slide bar 20 that is slidably displaceable relative to the housing 10. The slide bar 20 is configured for cooperating with a corresponding receiver 30 that is mounted to or mounted within a corresponding portion of a door frame 210 associated with the door 200 that is to be locked (see, for example, FIGS. 5 and 6). The latch or slide bar 20 is configured to extend through the housing and is disposed for sliding movement relative to the housing 10, when the housing 10 is disposed in an open condition, along an axis that extends transverse to a central longitudinal axis of the housing 10. A housing lock 40 is mounted to and/or incorporated into the housing 10 for locking the housing 10 in a closed position to prevent access to the interior of the housing 10. When the housing 10 is locked in the closed position by means of the housing lock 40, sliding displacement of the latch or slide bar 20 relative to the housing 10 is prevented, as will be described in further detail below.

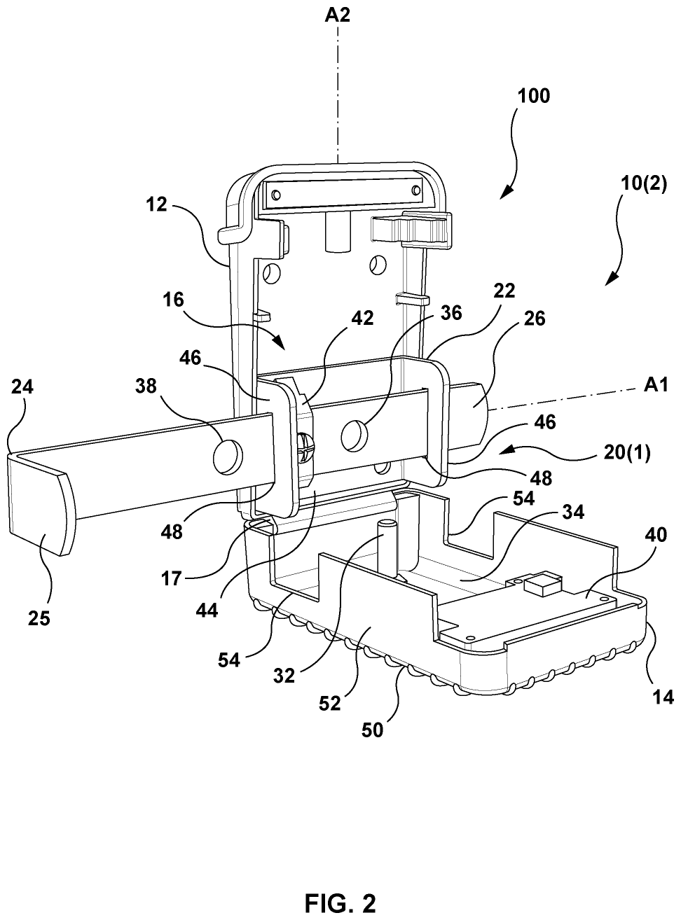

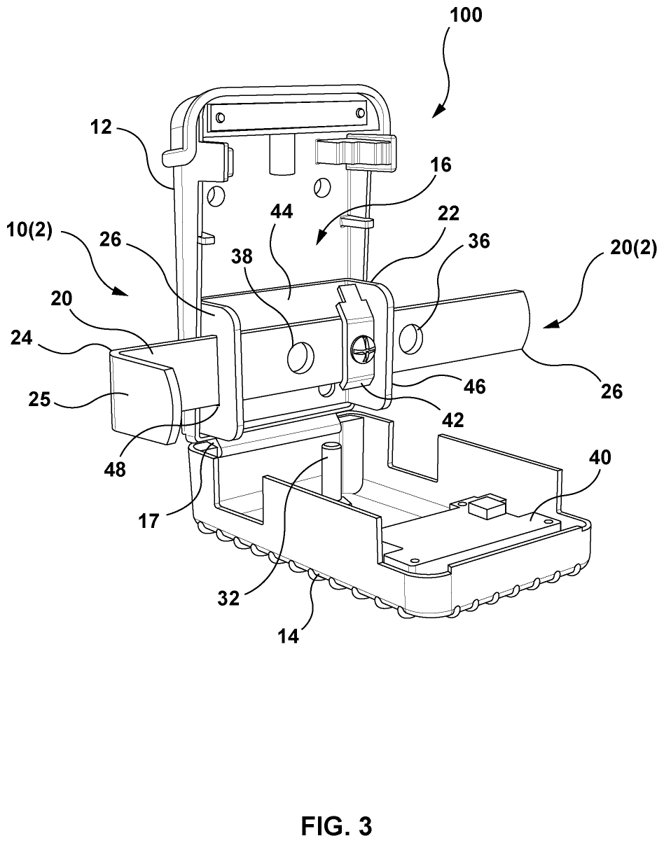

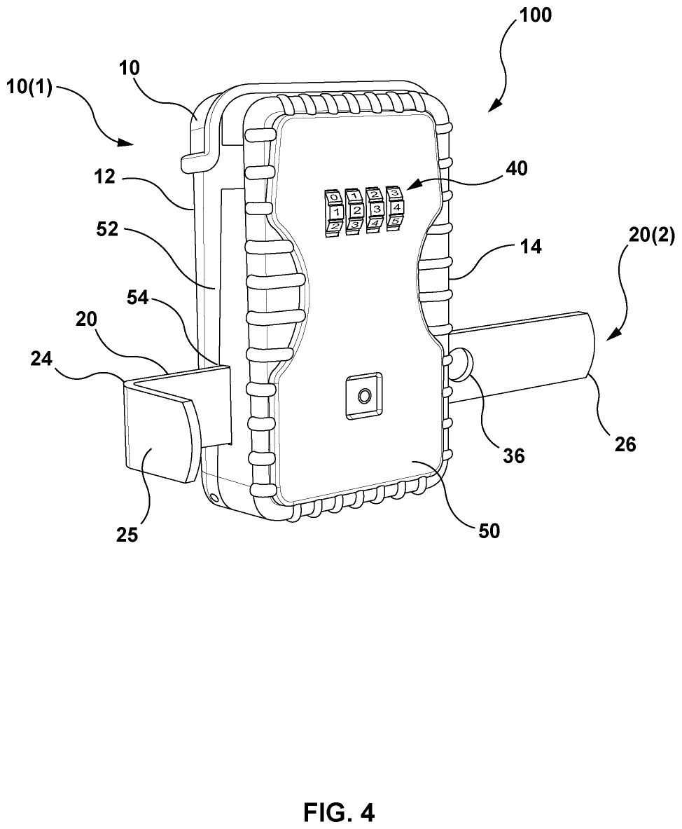

The housing 10 includes a back plate or base 12 and a cover portion 14. Together, the base 12 and the cover portion 14 enclose an open interior space, when the cover portion 14 is disposed relative to the base 12 such that the housing 10 is disposed in a closed position 10(1). In some embodiments, for example, the cover portion 14 is pivotally connected to the base 12 such that the cover portion 14 is pivotable, relative to the base 12, between the closed position 10(1), as illustrated for example in FIGS. 1 and 4, and an open position 10(2) as illustrated for example in FIGS. 2 and 3. While the cover portion 14 is disposed in the closed position 10(1), the base 12 and the cover portion 14 cooperate to enclose the open interior space 16. In some embodiments, for example, the cover portion 14 is pivotally connected to the base 12 via a hinge connection 17.

With reference, in particular to FIGS. 2 and 3, the latch or slide bar 20 is slidably mounted to the base 12 of the housing 10. In some embodiments, for example, the slide bar 20 is slidably mounted to the base 12 via a bracket member 22 that is fixed or otherwise connected to the base 12. The bracket member 22 is configured for supporting the slide bar 20 in a horizontal or transverse position relative to the housing 10 such that the slide bar 20 is disposed for displacement along an axis, A1, that extends transverse to a central axis, A2, of the housing 10. In some embodiments, for example, the central axis, A2, is a central longitudinal axis of the housing 10.

The bracket member 22 is mounted to the base 12 such that when the cover portion 14 is disposed in the closed position, the bracket member 22 is enclosed within the interior space 16 defined by the housing 10. The bracket member 22 supports the slide bar 20 in a horizontal or transverse position relative to the base 12 of the housing 10 while allowing for sliding displacement of the slide bar 20 relative to the bracket member 22 and base 12. The slide bar 20 is configured to slide, relative to the bracket member 22 between a first or unlatched position 20(1) wherein the slide bar 20 is disposed in a retracted position, relative to the corresponding receiver 30, as illustrated for example in FIG. 2 (see also FIG. 6), and a second, latched position 20(2), as illustrated in FIG. 3 (see also FIG. 5), wherein the slide bar 20 is disposed in an extended position for cooperating with the corresponding receiver 30. While the slide bar 20 is disposed in the first or unlatched position 20(1), the slide bar 20 is disposed in the retracted position relative to the housing 10 such that the slide bar 20 is disposed away from the corresponding receiver 30 that is disposed within the corresponding portion of the door frame 210 such that the slide bar 20 is free from interference with the corresponding receiver 30. While the slide bar 20 is disposed in the second, latched position 20(2), the slide bar 20 is disposed in an extended position, relative to the housing 10, wherein an end portion of the slide bar 20 is disposed for cooperating with the corresponding receiver 30 that is disposed within the corresponding portion of the door frame 210. While the slide bar 20 of the lock apparatus 100 is disposed in the second, latched position 20(2) and the end portion of the slide bar 20 is received within (or disposed for cooperation with) the corresponding receiver 30 such that displacement of the door 200 in a direction for opening of the door 200 is prevented due at least, in part, to interference between the end portion of the slide bar 20 and the receiver 30. See, for example, the example embodiment illustrated schematically in FIG. 5.

With reference again to FIGS. 2 and 3, the latch or slide bar 20 is an elongated member that is configured to extend through the housing 10. In this respect, in some embodiments, for example, the slide bar 20 extends between a first end portion 24 and a second end portion 26 that is disposed opposite to the first end portion 24 such that when the slide bar 20 is mounted to the base 12, the first end portion 24 is disposed outside of the housing 10 on one side of the housing 10 while the second end portion 26 is disposed outside of the housing on a second, opposite side of the housing 10. In some embodiments, for example, the first end portion 24 is configured to facilitate handling and operation of the slide bar 20 for sliding the slide bar 20 between the first, unlatched position 20(1) and the second, latched position 20(2). In this respect, in some embodiments, for example, the first end portion 24 includes a handle portion 25 wherein a portion of the first end portion 24 extends generally perpendicular to the plane of the slide bar 20. The second end portion 26 of the slide bar 20 is configured for cooperating with the corresponding slide bar-receiving member 30 and, in some embodiments, includes the generally planar end of the elongate member that forms the slide bar 20 that is configured for insertion into a corresponding space or cavity defined by the receiver 30.

The lock apparatus 100 further comprises a slide bar-interfering member 32 that is configured for securing the slide bar 20 relative to the housing 10 in either the first, unlatched position 20(1) or in the second, latched position 20(2), when the cover portion 14 is disposed in the closed position. As shown, for example, in FIGS. 2 and 3, in some embodiments, the slide bar-interfering member 32 is a cylindrical member, or a post, that extends generally perpendicular from an inner surface 34 of the cover portion 14 into the open interior space 16 defined by the housing 10. The slide bar-interfering member 32 is configured to be received within corresponding openings or slide bar-interfering member receivers 36, 38 that are formed in the slide bar 20 of the lock apparatus 100. More specifically, in the subject example embodiment, the latch or slide bar 20 includes a first opening or first slide bar-interfering member receiver 36 that is disposed within and extends through the side bar 20. The first slide bar-interfering member receiver 36 is configured such that when the slide bar 20 is disposed in the first, unlatched position 20(1), the first opening or slide bar-interfering member receiver 36 is disposed for receiving the slide bar-interfering member 32 as the cover portion 14 is pivoted, relative to the base 12 from the open position 10(2) to the closed position 10(1). Accordingly, disposition of the cover portion 14 in the closed position while the slide bar 20 is disposed in the first, unlatched position 20(1) is with effect that an end portion of the slide bar-interfering member 32 is disposed within the first opening or first slide bar-interfering member receiver 36 of the slide bar 20 such that displacement of the slide bar 20 from the first, unlatched position 20(1) to the second, latched position 20(2) is prevented due to interference between the slide bar-interfering member 32 and the slide bar 20.

A second opening or second slide bar-interfering member receiver 38 is disposed within and extends through the latch or slide bar 20, and is positioned relative to the first opening or first slide bar-interfering member receiver 36, such that when the slide bar 20 is disposed in the second, latched position 20(2), as illustrated for example in FIG. 3, the second slide bar-interfering member receiver 38 is disposed for receiving the end portion of the slide bar-interfering member 32 as the cover portion 14 is pivoted, relative to the base 12, from the open position 10(2) to the closed position 10(1). Accordingly, disposition of the cover portion 14 in the closed position while the slide bar 20 is disposed in the second, latched position 20(2) is with effect that an end portion of the slide bar-interfering member 32 is disposed within the second opening or second slide bar-interfering member receiver 38 of the slide bar 20 such that displacement of the slide bar 20 from the second, latched position 20(1) to the first, unlatched position 20(1) is prevented due to interference between the slide bar-interfering member 32 and the slide bar 20. The distance between the first and second slide bar-interfering member receivers 36, 38 will vary depending on the actual size and intended application of the lock apparatus 100. However, it will be understood that the distance between the first and second slide bar interfering member receivers 36, 38 as measured between the centers of each of the first and second slide bar interfering member receivers 36, 37 along transverse axis, A1, corresponds to the required distance of travel of the slide bar 20 or latch to securely engage the corresponding receiver 30 when disposed in the extended position and to clear the corresponding receiver 30 and door frame 210 so as not to interfere with the opening of the door 200 while in the retracted position. Due to the interference that is created between the slide bar 20 and the slide bar interfering member 32, when the cover portion 14 is disposed in the closed position, sliding displacement of the slide bar 20 between the first unlatched position 20(1) and the second latched position 20(2) is only effectible while the housing 10 is disposed in the open position 10(2) with the cover portion 14 opened or pivoted away from the base 12.

In order to ensure that displacement of the slide bar 20 between the first, unlatched position 20(1) and the second, latched position 20(2) is effective for positioning the second slide bar-interfering member receiver 38 relative to the base 12 such that the slide bar-interfering member 32 is received within the second opening 38 when the cover portion 14 is disposed in the closed position, and that displacement of the slide bar 20 between the second, latched position 20(2) and the first, unlatched position 20(1) is effective for positioning the first slide bar-interfering member receiver 36 relative to the base 12 such that the slide bar-interfering member 32 is received within the first opening 36 when the cover portion 14 is disposed in the closed position, in some embodiments, for example, the slide bar 20 includes a limiter 42 that is configured for limiting displacement of the slide bar 20 relative to the base 12. In some embodiments, for example, the limiter 42 is mounted on the slide bar 20 for limiting displacement of the slide bar 20 relative to the bracket member 22 that supports the slide bar 20 relative to the base 12. More specifically, as illustrated in the example embodiment of FIGS. 2-3, in some embodiments, for example, the bracket member 22 has a base portion 44 that is secured to the inner surface 13 of the base 12 and two flanged ends 46 that extend from opposite ends of the base portion 44 of the bracket member 44. Each flanged end 46, independently, extends perpendicular, or generally perpendicular, relative to the base portion 44 from an opposite end of the base portion 44 such that the base portion 44 extends between the flanged ends 46. Each flanged end 46 includes a slot, or opening, 48 through which the slide bar 20 is inserted. Accordingly, insertion of the slide bar 20 through the respective slots 48 provided in each of the flanged ends 46 of the bracket member 22 serves to support the slide bar 20 along the horizontal or transverse axis, A1, relative to the central axis A2 of the housing 10.

In such example embodiments, the limiter 42 is arranged on the slide bar 20 such that when the slide bar 20 is mounted within the bracket portion 22 and disposed for sliding movement relative to the bracket portion 22, the limiter 42 is disposed in between the pair of spaced apart flanged ends 46 of the bracket member 22 that supports slide bar 20 relative to the housing 10. As such, when the slide bar 20 is disposed in the first, unlatched position 20(1), the limiter 42 is disposed adjacent the flanged end 46 that is disposed most proximal to a first side of the housing 10 associated with the retracted position of the latch or slide bar 20. When the slide bar 20 is disposed in the second, latched position (as shown in FIG. 3), the limiter 42 is disposed proximal the flanged end 46 that is most proximal to a second, opposite side of the housing 10 associated with the extended or latched position of the slide bar 20. Disposition of the limiter 42 adjacent the respective one of the flanged ends 46 of the bracket portion 22 limits the overall displacement of the slide bar 20 relative to the bracket portion 22, due to interference between the limiter 42 and the corresponding flanged end 46, thereby preventing the slide bar 20 from being removed from the housing 10 as the slide bar 20 is retracted from the latched position. In some instances, the configuration of the handle portion 25 of the first end portion 24 of the slide bar 20 also serves to prevent the slide bar 20 from being completely removed from the housing 10, via sliding displacement through the housing 10. The contact between the limiter 42 and the respective one of the of the flanged ends 46 of the bracket portion 22 also ensures that the slide bar 20 is correctly positioned relative to the base 12 of the housing 10 so that upon closing of the cover portion 14, the slide bar-interfering member 32 will be received within the first opening 36 formed in the slide bar 20. This allows the cover portion 14 to be disposed in the closed position and allows the housing 10 to be locked in the closed position 10(1), via the housing lock 40, even when the latch or slide bar 20 is disposed in the first or unlatched condition 20(1). Sliding displacement of the slide bar 20, relative to the base 12 of the housing 10 along axis A1 from the first, unlatched position 20(1) to the second, latched position 20(2), while the cover portion 14 is disposed in the open position, brings the limiter 42 into contact with the opposite flanged end 46 of the bracket member 22 that is disposed most proximal to the second side of the housing 10, as shown, for example in FIG. 3. Contact between the limiter 42 and the flanged end 46 of the bracket member 22 as the slide bar 20 is displaced into the second, latched position 20(2) ensures that the second slide bar interfering member receiver 38, that is defined within the slide bar 20, is properly positioned for receiving the slide bar-interfering member 32 as the cover portion 14 is pivoted from the open position 10(2) into the closed position 10(1). In some embodiments, for example, contact between the limiter 42 and the corresponding flanged end 46 of the bracket member 22 when the slide bar 20 is disposed in the second, latched position ensures that the slide bar 20 is in the fully extended position for cooperating with the correspondence receiver 30. In some embodiments, the limiter 42 is an elongated body that is coupled to the slide bar 20 such that it extends transverse to the longitudinal axis of the slide bar 20. In some embodiments, for example, the limiter 42 is coupled to the slide bar 20 by a fastener, for example a screw.

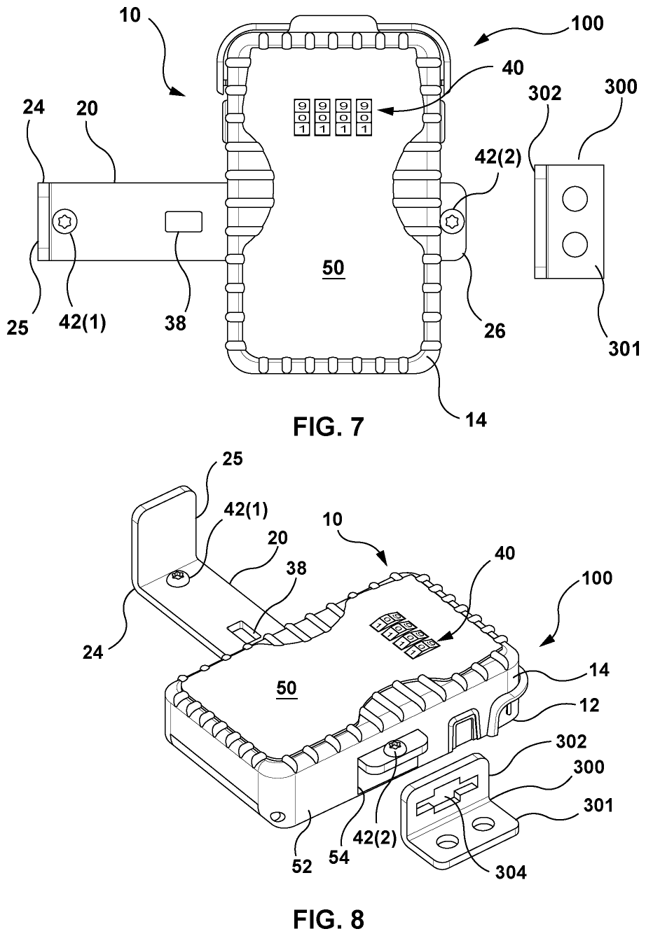

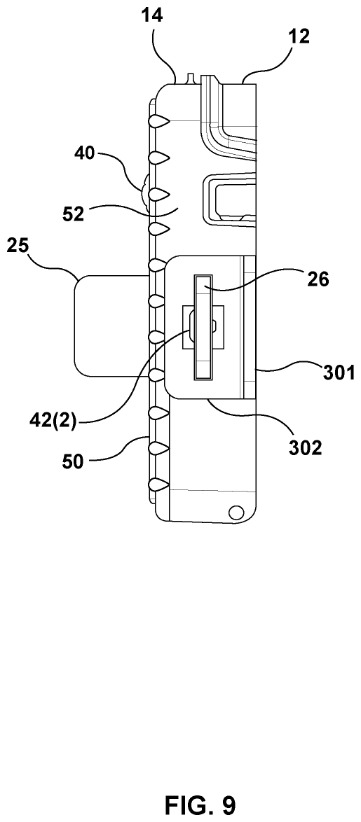

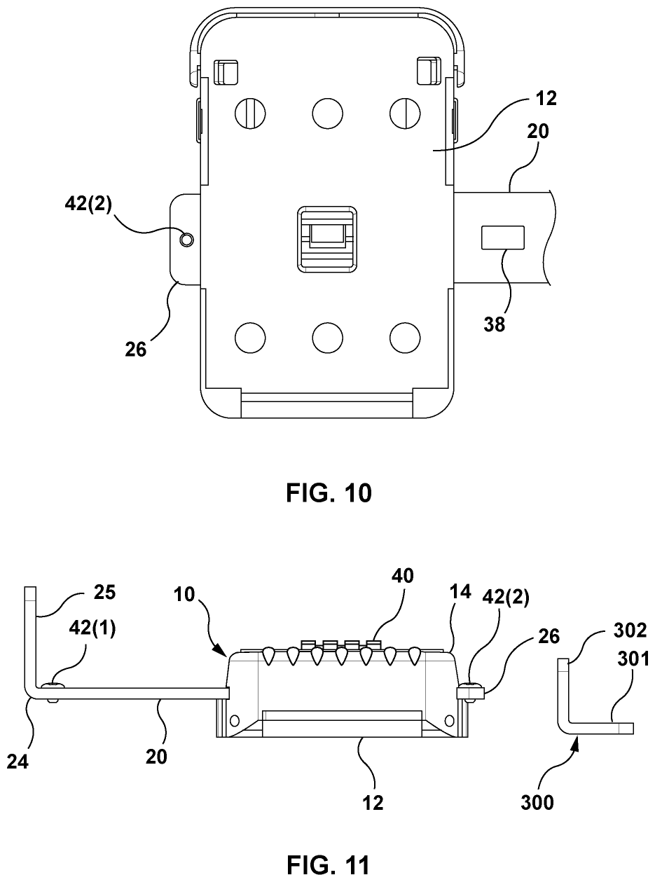

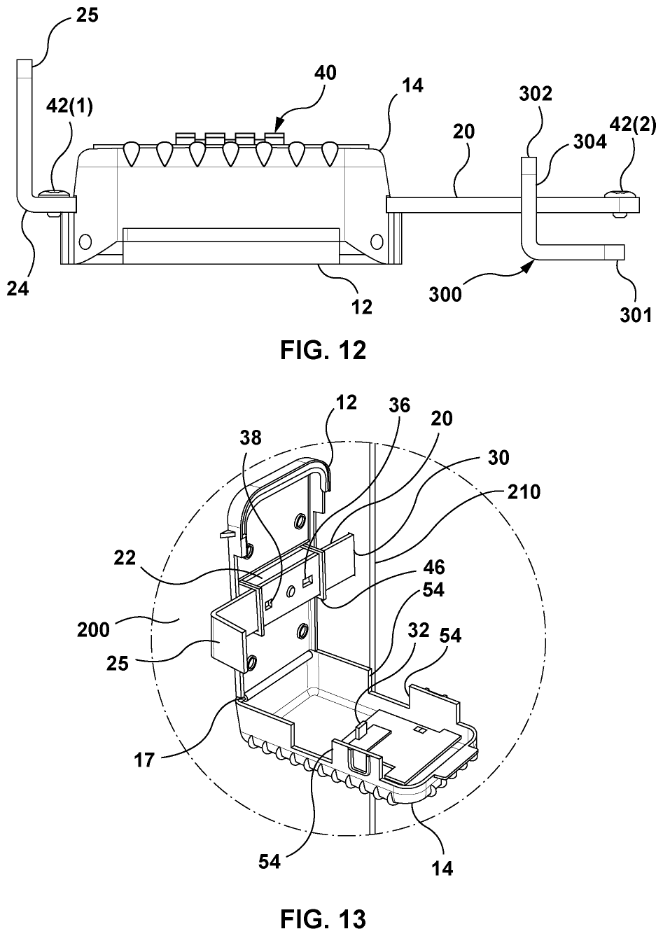

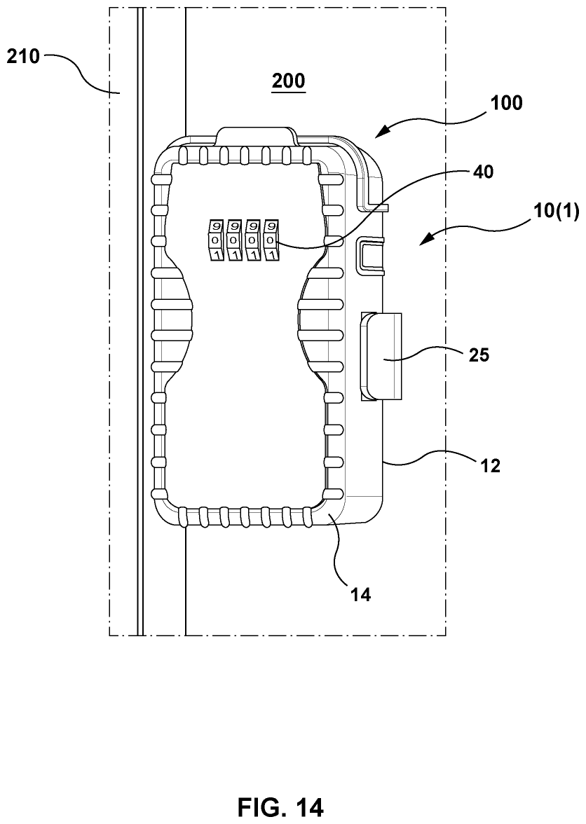

With reference now to FIGS. 7-14, in some embodiments, for example, rather than arranging a limiter 42 on the slide bar 42 such that the limiter 42 is disposed between the flanged ends 46 of the bracket portion 22 when the slide bar 20 is mounted within and disposed for sliding movement relative to the bracket portion 22, the limiter 42 includes: (i) a first displacement limiter 42(1) that is coupled proximal the first end 24 of the slide bar 20, and (ii) a second displacement limiter 42(2) that is coupled the slide bar 20 proximal the second end 26 thereof. In some embodiments, for example, the first displacement limiter 42(1) is coupled to the slide bar 20 proximal the handle portion 25, while the second displacement limiter 42(2) is disposed proximal the end of the slide bar 20 that is distal end of the handle portion 25 of the slide bar 20. In such example embodiments, while the slide bar 20 is disposed in the locked or latched position, the first displacement limiter 42(1) abuts the corresponding flanged end 46 of the bracket portion 22 thereby ensuring that the slide bar 20 is disposed in the fully extended, latched position. In such a position, the cover portion 14 of the housing can be pivoted into the closed position with the slide bar interfering member 32 being received within the second slide bar interfering member receiver 38 thereby securing the slide bar 20 in the locked position relative to the housing. When the cover portion 14 is pivoted into the open position such that the slide bar 20 is disposed for displacement relative to the base 12 of the housing, the slide bar 20 can be slidably displaced away from the latched position and into the open position, until the second displacement limiter 42(2) abuts the corresponding flanged end 46 of the bracket portion 22 thereby preventing the slide bar 20 from being unintentionally dislodged and/or removed from the bracket portion 22. Once in the open or unlatched position, the cover portion 14 can be pivoted into the closed position with the slide bar interfering member 32 being received within the first slide bar interfering member receiver 36 thereby securing the slide bar 20 in the open position relative to the housing. While the first and second displacement limiters 42(1), 42(2) may be accessible from the exterior of the lock apparatus 10, the positioning of the slide bar 20 cannot be tampered with once the cover portion 14 is locked and secured in the closed position, relative to the base 12, due to the interference created by the engagement between the slide bar 20 and the slide bar interfering member 32.

While the slide bar 20 is shown as being mounted to the base 12 and disposed for sliding movement from left to right between the first, unlatched position 20(1) and the second, latched position 20(2) in FIGS. 1-4, it will be understood that the slide bar 20 can also be mounted to the base 12 and disposed for sliding movement from right to left between the first, unlatched position 20(1) and the second, latched position 20(2) as shown in the example embodiment of FIGS. 5 and 6. Accordingly, the lock apparatus 100 is not limited to use in situations and/or arrangements that require sliding displacement from right to left, but can be easily modified and adapted for sliding movement from left to right.

With reference again to FIGS. 1-4, in some embodiments, for example, the cover portion 14 is a molded cover portion that includes front face 50 with a side wall 52 that extends rearwardly away from the front face about the perimeter of the front face 50. In some embodiments, for example, the cover portion 14 is molded from a plastic material. However, it will be understood that the cover portion 14 and the base 12 may be made from any suitable material for forming a robust housing 10 for the lock apparatus 100.

When the cover portion 14 is disposed in the closed position relative to the base 12 such that the housing 10 is disposed in the closed position 10(1), as shown for example in FIGS. 1 and 4, the side wall 52 of the cover portion is disposed in overlapping relationship with the outer edges of the base 12 thereby enclosing the interior space 16 defined by the base 12 and the cover portion 14. In some embodiments, for example, the overlapping relationship between the side wall 52 of the cover portion 14 and the base 12 is a sealing relationship so as to prevent access to the interior of the housing 10. In some embodiments, for example, in order to allow for closing of the cover portion 14 relative to the base 12 when the slide bar 20 is mounted relative to the base 12, the cover portion 14 is configured to accommodate the respective end portions 24, 26 of the slide bar 20 that extend through the housing 10. In this respect, in some embodiments, for example, the cover portion 14 of the housing includes notches 54 formed in the side wall of the cover portion 14 which allows the end portions 24, 26 of the slide bar 20 to extend outwardly through the housing 10, on either side thereof while still providing for an overlapping relationship between the remaining portions of the side wall 52 and the edges of the base 12.

As set out above, sliding displacement of the slide bar 20 relative to the housing 10 is only effectible while the housing 10 is disposed in the open position 10(1). Accordingly, in order to prevent unwanted or unauthorized access to the sliding mechanism of the slide bar 20, the housing 10 includes a housing lock 40 that is mounted to and/or otherwise integrated into the cover portion 14 of the housing 10. The housing lock 40 may be any conventional lock that is can be used for securing the cover portion 14 of the housing 10 in the closed position 10(1) so as to prevent access to the interior space 16 of the housing 10 that houses the sliding mechanism of the slide bar 20. This ensures that only users that can correctly operate the housing lock 40 can actuate the slide bar 20 of the lock apparatus 100. In some embodiments, for example, the housing lock 40 is a combination lock that includes a plurality of rotary dials 56 arranged in series. The rotary dials 56 can be set, by the user, to a unique combination that allows for operation of the housing lock 40 between a locked condition and an unlocked condition. Once the unique combination has been set by the user, when the rotary dials are disposed in the correct combination, the housing lock 40 is disposed in the open or unlocked condition which allows the cover portion 14 of the housing 10 to pivot from the closed position 10(1) into the open position 10(2). When the cover portion 14 is pivoted from the open position 10(2) into the closed position 10(1) and the rotary dials are scrambled, the housing lock 40 is disposed in a closed, or locked condition wherein the cover portion 14 cannot be pivoted relative to the base 12 from the closed position. Accordingly, the housing lock 40 operates in accordance with principles known in the art wherein operation of the housing lock 40 actuates a blocker (not shown) that is moveable between a non-interfering position which allows for pivoting of the cover portion 14 relative to the base 12 and an interfering position wherein the blocker interferes with pivoting movement and/or opening of the cover portion 14 thereby securing the cover portion 14 relative to the base 12 in the closed position. The mechanism that allows for operation of the housing lock 40 may be any suitable locking mechanism such as the conventional locking mechanism described in U.S. Pat. No. 7,251,967, the disclosure of which is hereby incorporated herein by reference.

Operation of the lock apparatus 100 will now be described in further detail with reference to FIGS. 1-5. In use, when the lock apparatus 100 is mounted to a door frame 210, a slide bar-receiving member 30 is mounted to an exterior surface of the door 200 that is to be secured in a closed position. In some embodiments, for example, the slide bar-receiving member 30 includes a latch plate or strike plate 300 that is mounted to a corresponding surface of the corresponding frame portion of the door that is to be secured. In some embodiments, the latch plate or strike plate 300 is in the form of an angle bracket or L-bracket having a first panel 301 configured for securing to a corresponding portion of the frame or receiver opening formed within the frame and a second panel 302 defining a slide bar receiving opening 304 that is configured to receive the distal end of the slide bar 20 when the slide bar 20 is slidably displaced in to the latched or locked position. In some embodiments, for example, the slide bar receiving opening 304 is configured to accommodate the first displacement limiter 42(2) to avoid unwanted interference between the first displacement limiter 42(2) and the latch plate or strike plate 300 that would otherwise prevent the slide bar 20 from being received through the slide bar receiving opening 304 as the slide bar 20 is displaced into the latched or fully extended position.

In order to operate the lock apparatus 100, first the housing lock 40 must be disposed in the open or unlocked condition in order to allow for pivoting of the cover portion 14 relative to the base 12. As shown in FIG. 1, when the housing lock 40 is in the form of a combination lock including a plurality of rotary dials, a user can enter the unique combination for the rotary dials which opens or unlocks the housing lock 40. Disposition of the housing lock 40 in the open or unlocked condition allows the cover portion 14 of the housing to be pivoted from the closed position to the open position, as shown for example in FIG. 2. Pivoting movement of the cover portion 14 away from the base 12 provides access to the sliding mechanism of the slide bar 20 and is with effect that the slide bar-interfering member is displaced away from the slide bar 20 and out of the interfering relationship with the slide bar 20. Accordingly, in instances where the slide bar 20 is disposed in the first, unlatched position 20(1) and the housing lock 40 is disposed in the unlocked condition such that the cover portion 14 is disposed in the open position, the slide bar-interfering member 20 is no longer disposed within the first slide bar-interfering member receiver 36 and the slide bar 20 can be displaced from the first, unlatched position 20(1), as shown in FIG. 2, to the second, latched position 20(2) as shown in FIG. 3. Disposition of the slide bar 20 in the second, latched position 20(2), while the door 200 is disposed in the closed position is with effect that the end portion 26 of the slide bar 20 is received within the corresponding receiver 30 that is mounted to the exterior surface of the door 200. See for instance the schematic illustration shown in FIG. 5. Once the slide bar 20 is disposed in the second, latched position 20(2), in order to prevent unauthorized sliding of the latch or slide bar 20 back into the first or unlatched position 20(1), the cover portion 14 can be pivoted relative to the base 12 and returned to the closed position. Returning of the cover portion 14 to the closed position is with effect that the slide bar interfering member 32 becomes disposed within the second slide bar interfering member receiver 38 of the slide bar 20. Disposition of the slide bar interfering member 32 within the second slide bar interfering member receiver 38 is with effect that the slide bar 20 cannot be displaced out of the latched or interfering position with the corresponding receiver 30 on the door frame 210 due to the interference between the slide bar interfering member 32 and the slide bar 20. Once the cover portion 14 is disposed in the closed position, the housing lock 40 can be locked, via scrambling of the rotary dials or via locking of the locking mechanism for securing the cover portion 14 in the closed position such that the housing 10 is disposed in the closed, locked condition thereby preventing unauthorized sliding displacement of the side bar 20 to the first or unlatched position that is required for opening of the door 200. Once the housing 10 is locked in the closed position 10(1), no further sliding displacement of the slide bar 20 is permitted until such time as the housing 10 is once again disposed in the open condition 10(2). The locked condition of the lock apparatus 100 for securing the door 200 in the locked condition is illustrated schematically in FIG. 5.

In order to open the door, the same procedure is followed in that first, the housing 10 must be disposed in the open condition 10(2), via unlocking of the housing lock 40. Once the housing lock 40 is disposed in the unlocked condition and the cover portion 14 is disposed in the open position, the user can slidingly displace the slide bar 20 from the second, latched position 20(2) to the first, unlatched position 20(1) as the slide bar interfering member 32 is no longer disposed within the second slide bar interfering member receiver 38 for preventing sliding movement of the slide bar 20 relative to the base 12. Once the slide bar 20 is slidingly displaced into the first, unlatched position 20(1), the door 200 can be opened, as illustrated schematically in FIG. 6 displacement of the door 200 from the closed position to the open position is no longer prevented by interference between the slide bar 20 and the corresponding receiver 30 of the door frame 210. Once the slide bar 20 is returned to the first, unlatched position 20(1), the cover portion 14 can be returned to the closed position which brings the slide bar interfering member 32 into interfering relationship with the slide bar 20 via emplacement of the slide bar interfering member 32 within the first slide bar interfering member receiver 36. Emplacement of the slide bar interfering member within the first slide bar interfering member receiver 36 prevents displacement of the slide bar 20 from the first, unlatched position 20(1) due to the interference between the slide bar interfering member 32 and the slide bar 20. Once the slide bar 20 is disposed in the first, unlatched position 20(1) and the cover portion 14 is disposed in the closed position such that the housing 10 is disposed in the closed condition 10(1), the housing lock 40 can be actuated so as to lock the housing 10 in the closed condition. Accordingly, the housing of the lock apparatus 100 can be conveniently closed while in the unlatched condition as well as while the slide bar 20 is disposed in the latched condition.

While specific example embodiments of the lock apparatus have been described, it will be understood that certain adaptations and modifications of the described embodiments can be made. Therefore, the above discussed embodiments are considered to be illustrative and not restrictive.

What is claimed is:

1. A lock apparatus, comprising:
a housing, the housing including:
a base; and
a cover portion pivotally connected to the base such that the cover portion is pivotable, relative to the base, between a closed position and an open position;
a slide bar mounted to the base, wherein the slide bar is disposed for sliding movement relative to the base between:
a first position, wherein the slide bar is disposed in a retracted position; and
a second position, wherein the slide bar is disposed in an extended position;
a slide bar-interfering member mounted to the cover portion and configured for preventing sliding movement of the slide bar between the first position and the second position while the cover portion is disposed in the closed position; and
a housing lock coupled to the housing and operable between a locked condition and an unlocked condition for securing the cover portion in the closed position;
wherein:
the base, the cover portion, the slide bar, the slide bar interfering member are cooperatively configured such that:
while the cover portion is disposed in the open position, the slide bar is displaceable between the between the first position and the second position, or vice versa; and
while the slide bar is disposed in either one of the first position and the second position, and while the cover portion is disposed in the closed position:
displacement of the slide bar slide bar from either the first position to the second position, or from the second position to the first position, is prevented via interference between the slide bar and the slide bar-interfering member.

2. The lock apparatus as claimed in claim 1, wherein:
while the cover portion is disposed in the open position:
there is an absence of interference between the slide bar and the slide bar-interfering member such that the sliding movement of the slide bar is permitted.

3. The lock apparatus as claimed in claim 1 or 2, wherein:
while the cover portion is disposed in the closed position and the housing lock is disposed in the locked condition, pivoting of the cover portion from the closed position to the open position is prevented.

4. The lock apparatus as claimed in claim 3, wherein:
disposition of the housing lock in the unlocked condition is with effect that pivoting of the cover portion from the closed position to the open position such that the housing is disposed in an open condition is permitted.

5. The lock apparatus as claimed in claim 1, wherein:
disposition of the cover portion in the closed position and disposition of the housing lock in the locked condition is effectible while the slide bar is disposed in the first position and in the second position.

6. The lock apparatus as claimed in any one of claims 1 to 5, wherein:
the slide bar is disposed for sliding movement in a direction transverse to a central axis of the housing.

7. The lock apparatus as claimed in any one of claims 1 to 6, wherein:
the slide bar includes:
a first slide bar-interfering member receiver configured for cooperating with the slide bar interfering member while the slide bar is disposed in the first position and the cover portion is disposed in the closed position; and
a second latch-interfering member, that is spaced apart from the first slide bar-interfering member receiver, and is configured for cooperating with the slide bar-interfering member while the slide bar is disposed in the second position and the cover portion is disposed in the closed position.

8. The lock apparatus as claimed in claim 7, wherein:
the slide bar-interfering member extends from an inner surface of the cover portion along an axis that is normal to at least a portion of the inner surface of the cover portion such that:
while the cover portion is disposed in the closed position, the slide bar-interfering member is disposed perpendicular to a central longitudinal axis of the slide bar.

9. The lock apparatus as claimed in claim 8, wherein:
while the slide bar is disposed in the first position, closing of the cover portion is with effect that an end portion of the slide bar interfering member is emplaced within the first slide bar interfering member receiver.

10. The lock apparatus as claimed in claim 9, wherein:
while the slide bar is disposed in the second position, closing of the cover portion is with effect that an end portion of the slide bar interfering member is emplaced within the second slide bar interfering member receiver.

11. The lock apparatus as claimed in any one of claims 1 to 10, wherein:
the slide bar-interfering member includes post.

12. The lock apparatus as claimed in claim 10, wherein:
emplacement of the end portion within one of the first slide bar interfering member receiver or the second slide bar interfering member receiver is effective for preventing sliding movement of the slide bar in a direction transverse to the axis of the slide bar-interfering member.

13. The lock apparatus as claimed in claim 7, wherein:
the first slide bar-interfering member receiver includes an opening that extends through the slide bar;
the second slide bar-interfering member receiver includes an opening that extends through the slide bar; and
disposition of the cover portion in the closed position while the slide bar is in one of the first position and the second position is with effect that the slide bar-interfering member extends through the corresponding opening defined by the corresponding one of the first slide bar-interfering member receiver and the second slide bar-interfering member receiver.

14. The lock apparatus as claimed in any one of claims 1 to 13, wherein:
the slide bar is an elongated member extending between a first end portion and second end portion; and
the slide bar is mounted to the base such that the first end portion extends outside the housing on a first side of the housing, and the second end portion extends outside the housing on a second side of the housing that is opposite to the first side.

15. The lock apparatus as claimed in claim 14, further comprising:
a bracket member configured for supporting the slide bar, relative to the base, along an axis that extends transverse to a central axis of the housing.

16. The lock apparatus as claimed in claim 1, wherein:
the housing lock is one of the following alternatives: a combination lock including a plurality of rotary dials configurable for having a unique code for effecting unlocking of the housing lock from the locked condition, or a keyed lock.

17. The lock apparatus as claimed in claim any one of claims 1 to 16, wherein:
the base, the cover portion, the slide bar and the slide bar interfering member are cooperatively configured such that displacement of the slide bar from the first position to the second position is effected via sliding movement of the slide bar in one of: a first direction of travel along an axis that extends parallel to a central longitudinal axis of the slide bar, or a second direction of travel that is opposite to the first direction such that the lock apparatus is configurable for use for securing a door that is mounted within a door frame in a closed position by cooperating with either a right hand side of the door frame or a left hand side of the door frame.

18. The lock apparatus as claimed in any one of claims 1 to 16, wherein:
the lock apparatus is configured for mounting to an exterior surface of a door mounted within a door frame wherein the door is mounted within the door frame and disposed for displacement relative to door frame between a closed position and an open position, the door frame comprising a receiver configured for cooperating with an end portion of the slide bar for securing the door in the closed position;
and
the lock assembly, the door, the door frame and the receiver member are co-operatively configured such that:
while the door is disposed in a closed position and the housing lock is disposed in the unlocked condition and the cover portion is disposed in the open position:
disposition of the slide bar in the second, extended position is with effect that the end portion of the slide bar is disposed within the receiver;
and
pivoting of the cover portion from the open position to the closed position, while the slide bar is disposed in the second position is with effect that the slide bar-interfering member is disposed within the second slide bar-interfering member receiver; and
disposition of the housing lock in the locked condition, while the cover portion is disposed in the closed position, is with effect that displacement of the door from the closed position to the open position is prevented to interference between the slide bar and the receiver and interference between the slide bar and the slide bar-interfering member.

19. A lock assembly for securing a door in a closed position, wherein the door is mounted relative to a frame member and is disposed for displacement relative to the frame member between a closed position wherein the door and the frame member share an interface, and an open position wherein the door is disposed relative to the frame member such that at least a portion of the shared interface is defeated, the lock assembly comprising:
a lock apparatus mounted on one of the door or a corresponding portion of the door frame; and
a receiver mounted on the other one of the door or the corresponding portion of the door frame;
the lock apparatus comprising:
a housing, the housing including:
a base; and
a cover portion pivotally connected to the base such that the cover portion is pivotable, relative to the base, between a closed position and an open position;
a slide bar mounted to the base, wherein the slide bar is disposed for sliding movement relative to the base between:
a first position, wherein the slide bar is disposed in a retracted position; and
a second position, wherein the slide bar is disposed in an extended position such that an end portion of the side bar is disposed within the receiver;
a slide bar-interfering member mounted to the cover portion and configured for preventing sliding movement of the slide bar between the first position and the second position while the cover portion is disposed in the closed position; and
a housing lock coupled to the housing and operable between a locked condition and an unlocked condition for securing the cover portion in the closed position;
wherein:
the base, the cover portion, the slide bar, the slide bar interfering member are cooperatively configured such that:
while the cover portion is disposed in the open position, the slide bar is displaceable between the between the first position and the second position, or vice versa; and
while the slide bar is disposed in either one of the first position and the second position, and while the cover portion is disposed in the closed position:
displacement of the slide bar slide bar from either the first position to the second position, or from the second position to the first position, is prevented via interference between the slide bar and the slide bar-interfering member.

20. The lock assembly as claimed in claim 19, wherein:
the door is a roll-up door mounted for displacement within a frame; and
the frame member is one of a left side frame member or a right side frame of the frame.

21. The lock assembly as claimed in claim 19 or 20, wherein:
the receiver is a strike plate configured for mounting to the door frame, the strike plate defining a slide bar receiving opening that extends through the strike plate for receiving a distal end of the slide bar when the slide bar is disposed in a fully extended position.

22. The lock apparatus as claimed in any one of claims 1 to 18 wherein the apparatus includes:
a slide bar displacement limiter mounted to the slide bar such that:
while the slide bar is disposed in the first position, the slide bar displacement limiter is disposed in a first interfering position for preventing continued displacement of the slide bar in the direction of travel for retracting the slide bar; and
while the slide bar is disposed in the second position, the slide bar displacement limited is disposed in a second interfering position for preventing continued displacement of the slide bar in the direction of travel for extending the slide bar.

23. The lock apparatus as claimed in claim 22, wherein:
while the slide bar displacement limiter is disposed in the first interfering position, the slide bar is disposed relative to the housing such that the first slide bar interfering member receiver is disposed for receiving the slide bar interfering member; and
while the slide bar displacement limiter is disposed in the second interfering position, the slide bar is disposed relative to the housing such that the second slide bar interfering member receiver is disposed for receiving the slide bar interfering member.

24. The lock apparatus as claimed in claim 22 or 23, wherein:
the slide bar displacement limiter includes:
a first slide bar displacement limiter coupled to a first end portion of the slide bar; and
a second slide bar displacement limiter coupled to a second end portion of the slide bar;
